(19) United States
(12) Patent Application Publication
(10) Pub. No.: US 2017/0269289 A1
(43) Pub. Date: Sep. 21, 2017

(54) BACKLIGHT MODULE AND DISPLAY DEVICE

(71) Applicants: Radiant Opto-Electronics (SuZhou) Co., Ltd, Suzhou City, Jiangsu (CN); Radiant Opto-Electronics Corporation, Kaohsiung City (TW)

(72) Inventors: Po-Chun TSAI, Kaohsiung City (TW); Yu-Wei CHANG, Kaohsiung City (TW); Chun-Hsien LI, Kaohsiung City (TW)

(21) Appl. No.: 15/124,019

(22) PCT Filed: Apr. 15, 2016
(86) PCT No.: PCT/CN2016/079440

§ 371 Date: May 4, 2017

(30) Foreign Application Priority Data
Feb. 25, 2016 (CN) 201610102805.6

(51) Int. Cl. F21V 8/00

(52) U.S. Cl. CPC G02B 6/0088; G02B 6/0055

(57) ABSTRACT

A backlight module is provided, including a first housing, a second housing, a light guide plate, a reflective plate, and at least one optical film. The first housing includes an accommodating space and a first wall surrounding the accommodating space. The second housing includes a second wall outside the first wall. The light guide plate and the reflective plate are disposed in the accommodating space, and the reflective plate is disposed between the light guide plate and the first housing. The optical film is disposed between the light guide plate and the second housing, and includes a first bending portion, wherein the first bending portion is disposed between the first wall and the second wall

### CROSS REFERENCE TO RELATED APPLICATIONS

The present application is the U.S. national phase under §371 of International Application No. PCT/CN2016/079440 filed Apr. 15, 2016, which claims priority from, China Patent Application No. 201610102805.6, filed on Feb. 25, 2016, the disclosure of which is hereby incorporated by reference herein in its entirety.

### BACKGROUND OF THE INVENTION

Field of the Invention

The application relates in general to a backlight module, and in particular, to a backlight module having an optical film.

Description of the Related Art

A backlight module (BLM) is an important part of a thin-film transistor liquid-crystal display (TFT-LCD). The backlight module can provide uniform light of high brightness, and the thin-film transistor liquid-crystal display can display images.

A conventional backlight module includes an optical film having an ear region, wherein a hole is formed on the ear region. The optical film can be fixed and suspended by the aforementioned ear region. However, the ear region may cause the width of the bezels of the backlight module to increase. The narrow border product cannot be achieved.

### BRIEF SUMMARY OF INVENTION

To address the deficiencies of conventional products, an embodiment of the invention provides a backlight module, including a first housing, a second housing, a light guide plate, a reflective plate, and at least one optical film. The first housing includes an accommodating space and a first wall surrounding the accommodating space. The second housing includes a second wall outside the first wall. The light guide plate and the reflective plate are disposed in the accommodating space, and the reflective plate is disposed between the light guide plate and the first housing. The optical film is disposed between the light guide plate and the second housing, and includes a first bending portion, wherein the first bending portion is disposed between the first wall and the second wall.

In some embodiments, the optical film has a flat portion and a first extending portion, and the first extending portion connects the flat portion with the first bending portion.

In some embodiments, the width of the first extending portion is substantially the same as that of the first bending portion.

In some embodiments, the width of the first bending portion exceeds that of the first extending portion.

In some embodiments, the first extending portion has a hole, and the first wall has a latching member, wherein the latching member passes through the hole.

In some embodiments, the first bending portion has a hole, and the first wall has a latching member, wherein the latching member passes through the hole.

In some embodiments, the first wall has a recess, and the first extending portion is accommodated in the recess.

In some embodiments, the optical film further comprises a second bending portion disposed between the first wall and the second wall, and the first bending portion and the second bending portion are located at the same side of the optical film.

In some embodiments, the optical film further comprises a second bending portion disposed between the first wall and the second wall, and the first bending portion and the second bending portion are located at the opposite sides of the optical film.

A display device is also provided in the invention, comprising the aforementioned backlight module and a display panel. The display panel is disposed on the front of the light guiding plate of the backlight module, and the optical film is disposed between the display panel and the light guiding plate.

### BRIEF DESCRIPTION OF DRAWINGS

The invention can be more fully understood by reading the subsequent detailed description and examples with references made to the accompanying drawings, wherein:

FIG. 1 is a schematic diagram of a backlight module according to an embodiment of the invention;

FIG. 2 is an exploded-view diagram of a backlight module according to an embodiment of the invention;

FIG. 3 is an enlarged partial schematic diagram of a backlight module according to an embodiment of the invention, wherein a second housing is omitted;

FIG. 4A is a cross-sectional view along the line x-x in FIG. 1;

FIG. 4B is a cross-sectional view along the line y-y in FIG. 1;

FIG. 5 is an enlarged partial schematic diagram of a backlight module according to another embodiment of the invention, wherein a second housing is omitted;

FIG. 6A is an enlarged partial schematic diagram of a backlight module according to another embodiment of the invention, wherein the second housing is omitted;

FIG. 6B is an enlarged partial schematic diagram of a backlight module according to another embodiment of the invention, wherein the second housing is omitted;

FIGS. 7A and 7B are schematic diagrams of a backlight module according to another embodiment of the invention; and

FIG. 8 is a schematic diagram of a display system according to an embodiment of the invention.

### DETAILED DESCRIPTION OF INVENTION

The making and using of the embodiments of the backlight module are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood to one of ordinary skill in the art to which this invention belongs. It should be appreciated that each term, which is defined in a commonly used dictionary, should be interpreted as having a meaning conforming to the relative skills and the background or the context of the present disclosure, and should not be interpreted by an idealized or overly formal manner unless defined otherwise.

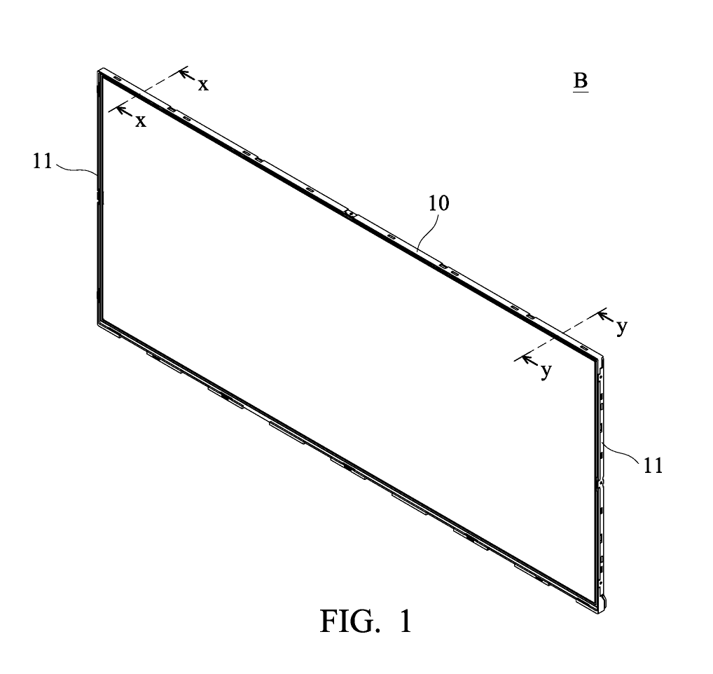

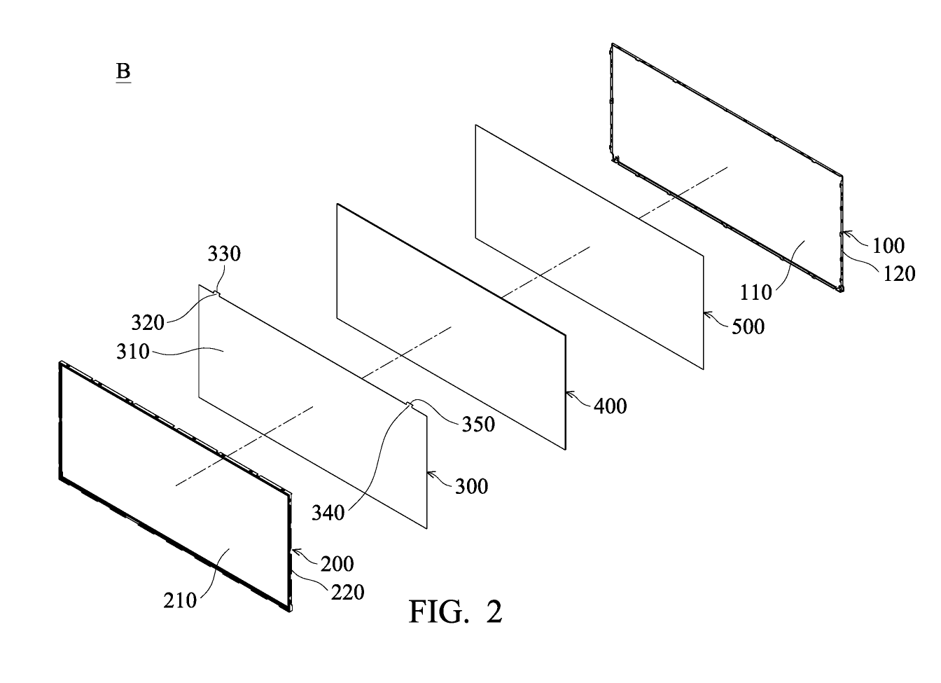

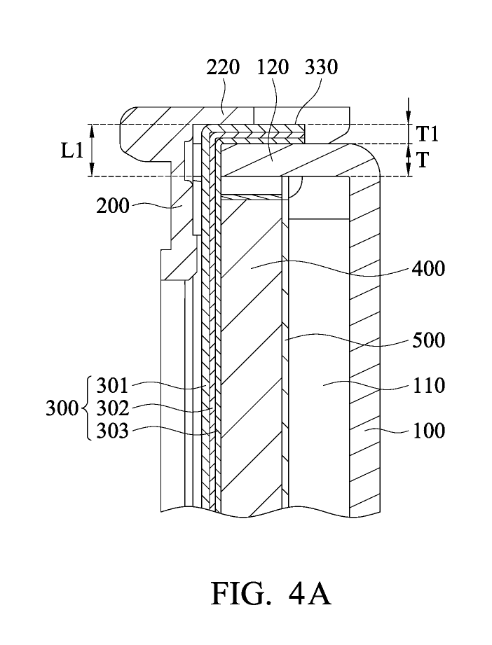

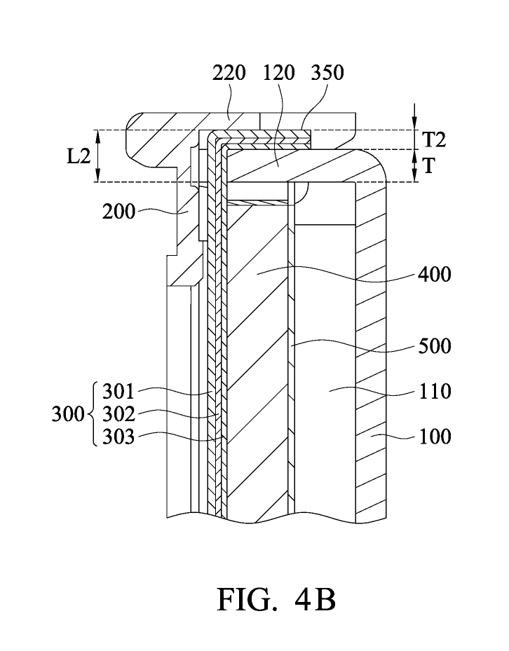

First, referring to FIGS. 1 and 2, a backlight module B in an embodiment of the invention primarily comprises a first housing 100, a second housing 200, at least one optical film 300, a light guiding plate 400, and a reflective plate 500, wherein the optical film 300, the light guiding plate 400, and the reflective plate 500 are disposed between the first housing 100 and the second housing 200. Furthermore, the backlight module B can comprise a single optical film 300 or a plurality of optical films 300. The number of optical films 300 can be adjusted as required. FIG. 2 shows one optical film 300 (two other optical films 300 are omitted), and FIGS. 4A and 4B show three optical films 300. Moreover, the first housing 100 is a backplate or cover in the field of the backlight module B, and the second housing 200 is a mold frame in the field of the backlight module B.

The first housing 100 comprises an accommodating space 110 and a first wall 120, and the first wall 120 is disposed outside the accommodating space 110 and surrounds it. The second housing 120 comprises an opening 210 and a second wall 220.

Referring to FIGS. 1-3, the optical film 300 comprises a flat portion 310, a first extending portion 320, a first bending portion 330, a second extending portion 340, and a second bending portion 350. The first extending portion 320 connects the flat portion 310 with the first bending portion 330. The second extending portion 340 connects the flat portion 310 with the second bending portion 350. The first and second bending portions 330, 350 are substantially extended along the normal direction of the flat portion 310. In this embodiment, the first bending portion 330 and the second bending portion 350 are formed on the same side of the flat portion 310. Therefore, when the backlight module B is upright, the optical film 300 can be suspended on the top side 10 of the backlight module B.

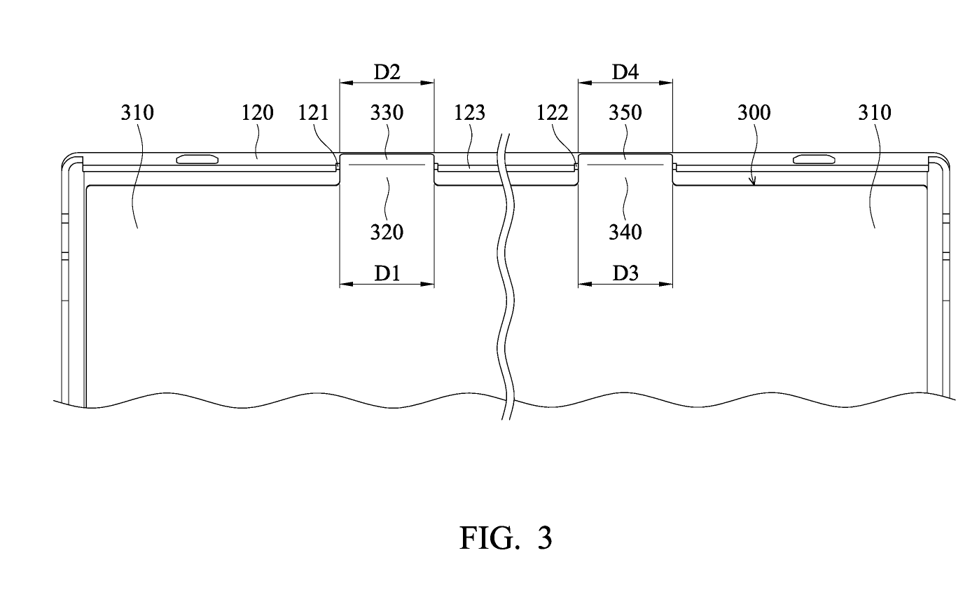

As shown in FIG. 3, the first extending portion 320 and the second extending portion 340 can respectively be accommodated in recesses 121 and 122 of the first wall 120. The surfaces of the flat portion 310 and the first and second extending portions 320, 340 can be coplanar or below than that of the first wall 120, so that the thickness of the backlight module B can be reduced.

It should be noted that the number, dimensions, or position of the extending portions and the bending portions can be adjusted according to the dimensions of the flat portion 310, and are not limited to those illustrated in FIG. 2. For example, in some embodiments, the first bending portion 330 and the second bending portion 350 can be formed on opposite sides of the optical film 300. When the backlight module B is upright, the optical film 300 can be suspended on the lateral sides 11 of the backlight module B. In some embodiments, when the dimensions of the flat portion 310 is small, the optical film 300 can merely comprise the first extending portion 320 and the first bending portion 330 (the second extending portion 340 and the second bending portion 350 are omitted).

FIG. 4A is a cross-sectional view of the backlight module B in FIG. 1 along the line x-x. As shown in FIG. 4A, when the backlight module B is assembled, the first housing 100 and the second housing 200 are engaged, the second wall 220 of the second housing 200 is outside of the first wall 120 of the first housing 100, and the first bending portion 330 of the optical film 300 is clamped between the first wall 120 and the second wall 220. Thus, the optical film 300 can be fixed without any locking members or mechanisms, and the width of the bezels of the backlight module B can be reduced. The narrow borders of the backlight module B can be achieved. Furthermore, the light guiding plate 400 and the reflective plate 500 are disposed in the accommodating space 110 of the first housing 100. The light guiding plate 400 is disposed between the optical film 300 and the reflective plate 500. The optical film 300 is disposed between the light guiding plate 400 and the second housing 200.

FIG. 4B is a cross-sectional view of the backlight module B in FIG. 1 along the line y-y. Similarly, as shown in FIG. 4B, when the backlight module B is assembled, the second bending portion 350 of the optical film 300 is clamped between the first wall 120 and the second wall 220 for fixing the optical film 200.

As shown in FIGS. 4A and 4B, in this embodiment, the optical film 300 is a three-piece structure, including an upper diffusion film 301, a prism film 302, and a lower diffusion film 303. The prism film 302 is disposed between the upper diffusion film 301 and the lower diffusion film 303. The upper diffusion film 301 and the lower diffusion film 303 are used to diffuse the light from the light guiding plate 400, such that the distribution of the light can be transferred as a uniform surface light. The prism film 302 is used to increase the brightness of light.

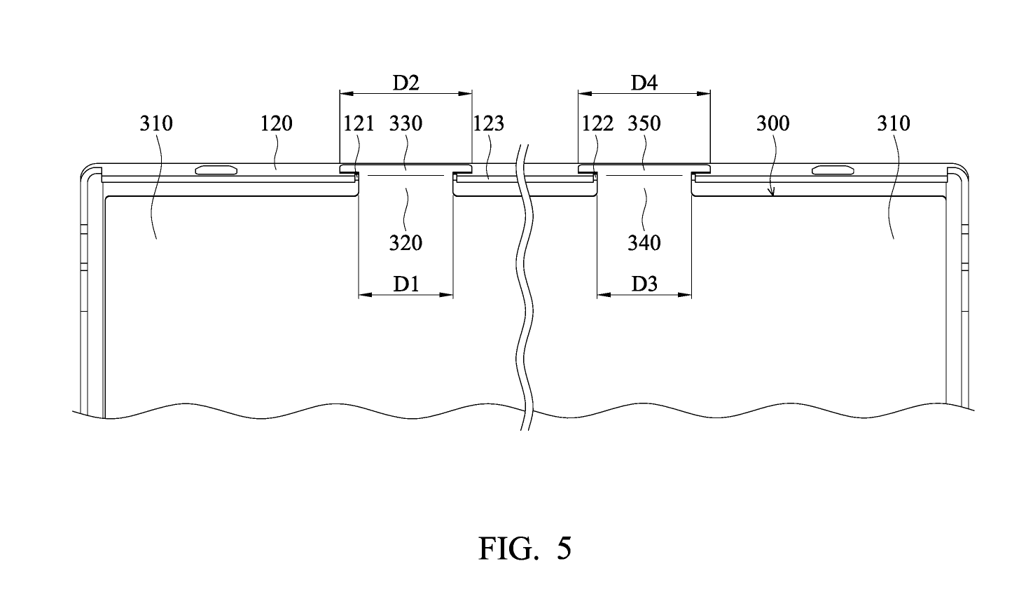

As shown in FIG. 3, in the aforementioned embodiment, the width D1 of the first extending portion 320 is substantially the same as the width D2 of the first bending portion 330, and the width D3 of the second extending portion 350 is substantially the same as the width D4 of the second bending portion 350. Therefore, the number of steps required for forming the optical film 300 can be reduced. Referring to FIG. 5, in another embodiment, the width D2 of the first bending portion 330 exceeds the width D1 of the first extending portion 320, and the width D4 of the second bending portion 350 exceeds the width D3 of the second extending portion 350. The reliability of the fixing of the optical film 300 can be increased.

Furthermore, in some embodiments, the lengths L1, L2 of the first and second extending portions 320, 340 are equal to the thicknesses T1, T2 of the first and second bending portions 330, 350 plus the thickness T of the first wall 120 (FIGS. 4A and 4B). The area of the flat portion 310 can be maximized.

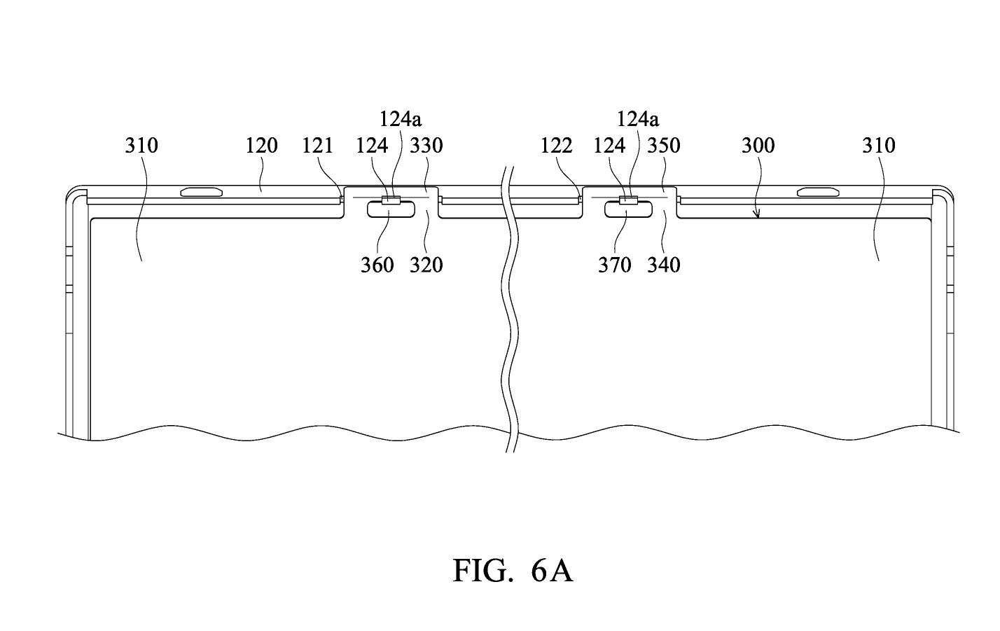

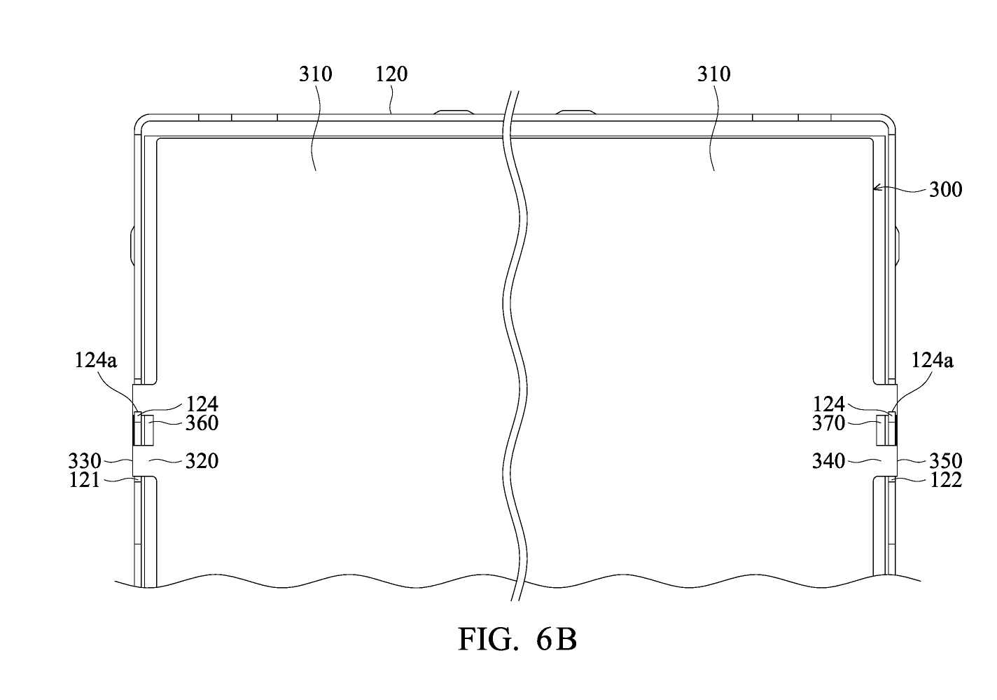

Referring to FIGS. 6A and 6B, in some embodiments, holes 360, 370 are respectively formed on the first and second extending portions 320, 340, and the latching members 124 are formed on the first wall 120. The latching members 124 pass through the holes 360, 370 for preventing the optical film 300 from dropping due to a large gap formed between the first wall 120 and the second wall 220 when the backlight module B is impacted. It should be note that, in the embodiment of FIGS. 6A and 6B, the latching member 124 has a hook portion 124a extending toward the top side 10 of the backlight module B. That is, the hook portion 124a extends from bottom to top, and the optical film 300 can be suspended on the first wall 120.

Two structures of the hook portion 124a on the top side 10 and lateral sides 11 of the backlight module B are discussed below. As shown in FIG. 6A, in this embodiment, the first and second bending portions 330, 350 are disposed on the same side of the optical film 330, such that the optical film 300 can be suspended on the top side 10 of the backlight module B when the backlight module B is upright, and the hook portions 124a are engaged with the first and second bending portions 330 and 350 of the optical film 300. As shown in FIG. 6B, in this embodiment, the first and second bending portions 330, 350 are disposed on opposite sides of the optical film 300, so that the optical film 300 can be suspended on the lateral sides 11 of the backlight module B when the backlight module B is upright, and the hook portions 124a are engaged with the first and second extending portions 320 and 340 of the optical film 300 without being engaged with the first and second bending portions 330, 350 as shown in FIG. 6A.

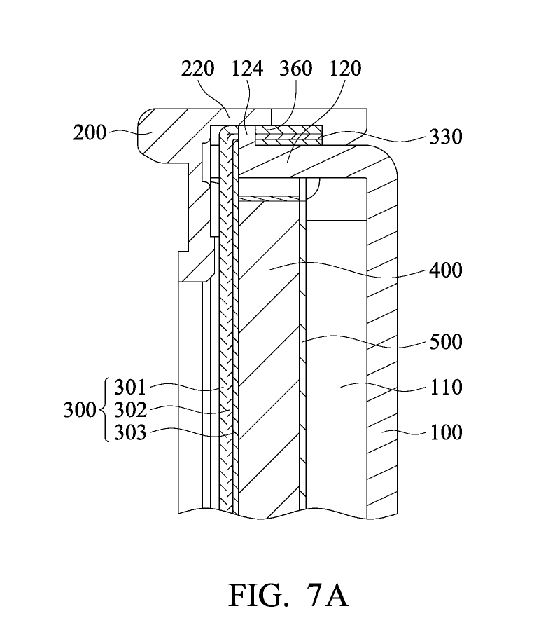

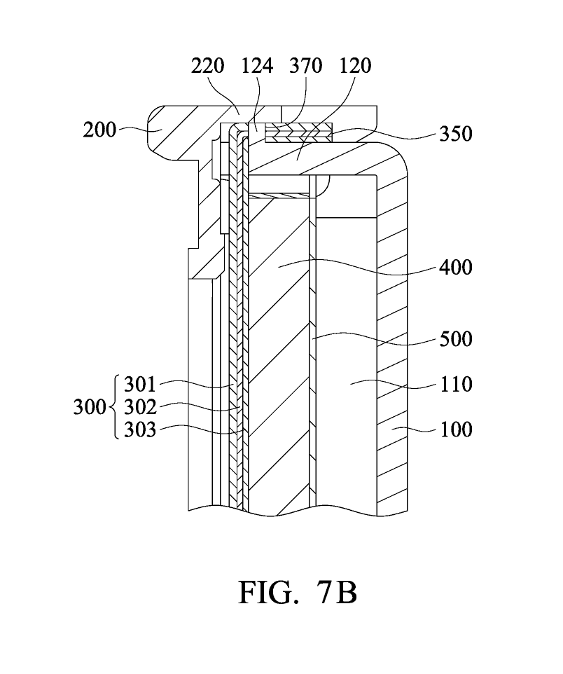

Referring to FIGS. 7A and 7B, in some embodiments, the holes 360, 370 can be formed on the first and second bending portions 330, 350, and the latching members 124 on the first wall 120 pass through the holes 360, 370.

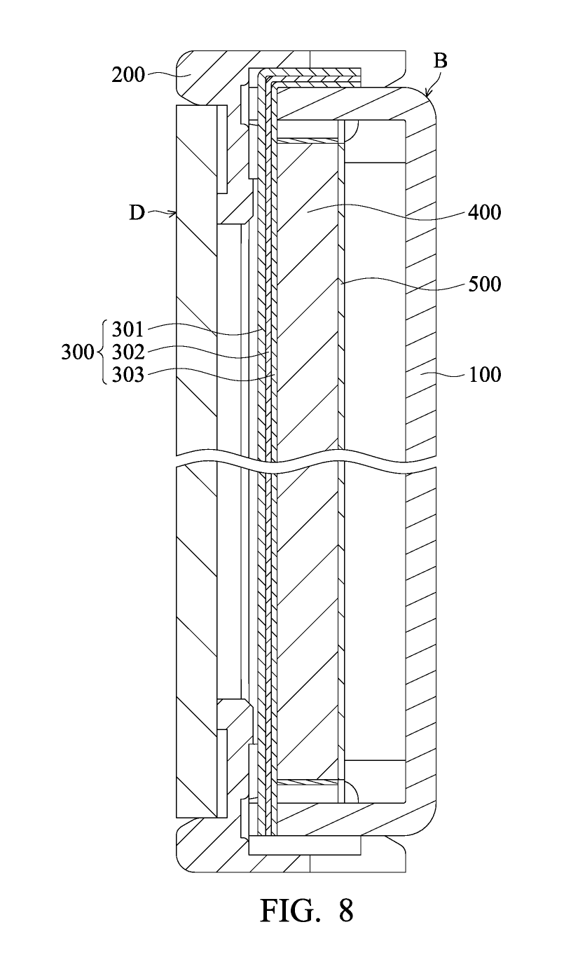

Referring to FIG. 8, a display device in an embodiment of the invention can comprise any one of the aforementioned backlight module B and a display panel D. The display panel D is disposed on the front of the backlight module B, and the optical film 300 is disposed between the display panel D and the light guiding plate 400.

In summary, a backlight module is provided. The first and second bending portions of the optical film can be clamped between the first wall of the first housing and the second wall of the second housing, such that the optical film can be fixed without other locking members or mechanisms, and the thickness of the bezels of the backlight module can be reduced. The backlight module having narrow borders can be achieved.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

1. A backlight module, comprising:
a first housing, comprising an accommodating space and a first wall, wherein the first wall surrounds the accommodating space;
a second housing, comprising a second wall, wherein the second wall is disposed outside the first wall;
a light guiding plate, disposed in the accommodating space;
a reflective plate, disposed in the accommodating space, and between the light guiding plate and the first housing; and
at least one optical film, disposed between the light guiding plate and the second housing and comprising a first bending portion, wherein the first bending portion is disposed between the first wall and the second wall.

2. The backlight module as claimed in claim 1, wherein the optical film further comprises a flat portion and a first extending portion, and the first extending portion connects the flat portion with the first bending portion.

3. The backlight module as claimed in claim 2, wherein the width of the first extending portion is substantially the same as that of the first bending portion.

4. The backlight module as claimed in claim 2, wherein the width of the first bending portion exceeds that of the first extending portion.

5. The backlight module as claimed in claim 2, wherein the first extending portion has a hole, and the first wall has a latching member, wherein the latching member passes through the hole.

6. The backlight module as claimed in claim 2, wherein the first bending portion has a hole, and the first wall has a latching member, wherein the latching member passes through the hole.

7. The backlight module as claimed in claim 2, wherein the first wall has a recess, and the first extending portion is accommodated in the recess.

8. The backlight module as claimed in claim 1, wherein the optical film further comprises a second bending portion, disposed between the first wall and the second wall, and the first bending portion and the second bending portion are disposed on the same side of the optical film.

9. The backlight module as claimed in claim 1, wherein the optical film further comprises a second bending portion, disposed between the first wall and the second wall, and the first bending portion and the second bending portion are disposed on the opposite sides of the optical film.

10. A display device, comprising:
a backlight module as claimed in claim 1; and
a display panel, disposed on the front of the light guiding plate of the backlight module, wherein the optical film is disposed between the display panel and the light guiding plate.
